(19) United States
(12) Patent Application Publication
(10) Pub. No.: US 2019/0210057 A1
(43) Pub. Date: Jul. 11, 2019

(54) COATING DEVICE AND COATING METHOD

(71) Applicant: FUJIFILM Corporation, Tokyo (JP)

(72) Inventors: Nobuyuki SONE, Fujinomiya-shi (JP); Takahiro SAKAMOTO, Fujinomiya-shi (JP); Atsushi OSHIMA, Fujinomiya-shi (JP)

(73) Assignee: FUJIFILM Corporation, Tokyo (JP)

(21) Appl. No.: 16/353,650

(22) Filed: Mar. 14, 2019

Related U.S. Application Data
(63) Continuation of application No. PCT/JP2017/033927, filed on Sep. 20, 2017.

(30) Foreign Application Priority Data
Sep. 29, 2016 (JP) 2016-191352

(51) Int. Cl. B05C 11/02; B05C 3/18; B05C 1/08; B05D 1/28; B05D 7/04; D21H 25/12

(52) U.S. Cl. CPC B05C 11/025; B05C 3/18; D21H 25/12; B05D 1/28; B05D 7/04; B05C 1/0826

(57) ABSTRACT

Provided are a coating device and a coating method which suppress the occurrence of exhaustion of a coating liquid. A coating device which applies a coating liquid to an upper surface or a lateral surface of a long substrate continuously traveling in a specific traveling direction has: a bar which is capable of being brought into contact with the upper surface or the lateral surface of the long substrate continuously traveling in the specific traveling direction via the coating liquid, and is rotated; and at least two stages of dam plates which are provided on the upstream side in the traveling direction of the long substrate with respect to the bar, and allow the coating liquid to flow to the long substrate via a space between the dam plate and the bar. The at least two stages of dam plates are arranged along the traveling direction.

### CROSS-REFERENCE TO RELATED APPLICATIONS

This application is a Continuation of PCT International Application No. PCT/JP2017/033927 filed on Sep. 20, 2017, which claims priority under 35 U.S.C. § 119(a) to Japanese Patent Application No. 2016-191352 filed on Sep. 29, 2016. The above application is hereby expressly incorporated by reference, in its entirety, into the present application.

### BACKGROUND OF THE INVENTION

### 1. Field of the Invention

The present invention relates to a coating device using a bar and a coating method, and particularly, to a coating device and a coating method adapted for applying various liquid substances to a sheet-like or long base material to be coated, such as a thin metal plate, paper, or a film.

### 2. Description of the Related Art

In forming a functional layer such as an easy adhesion layer or an antistatic layer on a surface of a long substrate, a coating liquid has been applied to the surface of the substrate to form a coating film. As a method of applying the coating liquid to the surface of the substrate, a large number of coating methods such as a roll coating method, a die coating method, a spray coating method, and a bar coating method have been known. The long substrate is also referred to as a web. In addition, the long substrate is also simply referred to as a substrate.

As a method of simultaneously coating both surfaces of the substrate and drying the surfaces, a method for bar coating from the upper surface side or the lateral surface side is effectively used. However, in a case where the web is coated from the upper surface or the lateral surface thereof at a high speed, a failure such as exhaustion of the coating liquid occurs. The liquid exhaustion occurs from a place where the liquid amount is small since the coating liquid is not uniformly distributed in a width direction due to the base with poor smoothness. The liquid exhaustion becomes a problem since the manufacturing yield is greatly reduced. In addition, cissing may occur due to air entrainment in coating with the coating liquid, or coating failure such as bubble cissing may occur.

The cissing due to air entrainment in coating with the coating liquid occurs as the liquid pressure of the coating device is less than the dynamic pressure of the entrained air generated in the outermost surface of the substrate as will be described in detail later.

Although will be described in detail later, the bubble cissing occurs due to the following reason. In a case where bubbles are introduced from a liquid feeding system or the like, the bubbles accumulate in the coating device, and in a case where the bubbles reach a saturated state, the bubbles are brought to the substrate, and thus the bubble cissing occurs. The two coating failures also lead to a reduction in manufacturing yield.

A coating device which applies a coating liquid to an upper surface of a substrate is described in JP2015-077589A. The coating device in JP2015-077589A has: bars which are rotated in contact with an upper surface of a continuously traveling web via a coating liquid; and a dam plate provided on the upstream side of the web traveling direction with respect to the bar, and allowing the coating liquid to flow in a web direction via a space between the dam plate and the bar. In the coating device in JP2015-077589A, in a case where a distance between the dam plate and an end edge portion of the bar which is the closest to the dam plate is represented by A, and a distance between the web and the dam plate is represented by B, A is 0.5 to 5 mm, B is 0.5 to 5 mm, and BA is satisfied.

### SUMMARY OF THE INVENTION

In JP2015-077589A described above, it is described that the coating liquid is applied to the upper surface of the web which continuously travels. However, it does not consider the exhaustion of the coating liquid, and problems concerning the liquid exhaustion are not found in JP2015-077589A.

An object of the invention is to provide a coating device and a coating method which solve the problems based on the above-described related art and suppress the occurrence of exhaustion of a coating liquid.

In order to achieve the above-described object, according to the invention, there is provided a coating device which applies a coating liquid to an upper surface or a lateral surface of a long substrate continuously traveling in a specific traveling direction, comprising: a bar which is capable of being brought into contact with the upper surface or the lateral surface of the long substrate continuously traveling in the traveling direction via the coating liquid, and is rotated; and at least two stages of dam plates which are provided on the upstream side in the traveling direction of the long substrate with respect to the bar, and allow the coating liquid to flow to the long substrate via a space between the dam plate and the bar, in which the at least two stages of dam plates are arranged along the traveling direction.

In a case where a cross-sectional area of a first portion surrounded by the bar, a dam plate closest to the bar among the dam plates, and the long substrate in a plane formed by the traveling direction and a height direction is defined as a first bead cross-sectional area, and a cross-sectional area of a second portion surrounded by the dam plate closest to the bar, a dam plate on the most upstream side in the traveling direction among the dam plates, and the long substrate in the plane formed by the traveling direction and the height direction is defined as a second bead cross-sectional area, a sum of the first bead cross-sectional area and the second bead cross-sectional area is preferably 20 mm² or greater, a distance between the dam plate on the most upstream side and the long substrate is preferably 0 mm to 5 mm, and the height direction is preferably a direction perpendicular to the upper surface or the lateral surface of the substrate.

In a case where a cross-sectional area of a first portion surrounded by the bar, a dam plate closest to the bar among the dam plates, and the long substrate in a plane formed by the traveling direction and a height direction is defined as a first bead cross-sectional area, the first bead cross-sectional area is preferably 20 mm² or less, the shortest distance between an end surface of the bar on the upstream side in the traveling direction and the dam plate closest to the bar is preferably 0.05 mm to 2 mm, a distance between the dam plate closest to the bar and the long substrate is preferably 0.2 mm to 2 mm, and the height direction is preferably a direction perpendicular to the upper surface or the lateral surface of the substrate.

The coating device preferably further comprises a main body block which rotatably supports the bar, and a fed-liquid storage portion which is provided in the main body block or the dam plate to store the coating liquid.

The coating device preferably further comprises a side plate which is provided at ends of the bar and the at least two stages of dam plates in a width direction orthogonal to the traveling direction in the upper surface or the lateral surface of the substrate.

According to the invention, there is provided a coating method comprising: applying a coating liquid to an upper surface or a lateral surface of a long substrate continuously traveling by using the above-described coating device.

According to the invention, it is possible to suppress the occurrence of exhaustion of a coating liquid.

### BRIEF DESCRIPTION OF THE DRAWINGS

FIG. 1 is a schematic view showing a coating device according to an embodiment of the invention.

FIG. 2 is a schematic perspective view showing a main part of the coating device according to the embodiment of the invention.

FIG. 3 is a schematic view showing a traveling state of a long substrate.

FIG. 4 is a schematic view for illustrating an operation of the coating device according to the embodiment of the invention.

FIG. 5 is a schematic view for illustrating another operation of the coating device according to the embodiment of the invention.

FIG. 6 is a schematic perspective view showing a side plate of the coating device according to the embodiment of the invention.

FIG. 7 is a schematic view showing another example of the coating device according to the embodiment of the invention.

FIG. 8 is a schematic perspective view showing a side plate of another example of the coating device according to the embodiment of the invention.

FIG. 9 is a schematic view for illustrating exhaustion of a coating liquid.

FIG. 10 is a schematic view for illustrating cissing due to air entrainment.

FIG. 11 is a schematic plan view showing a result of coating including exhaustion of a coating liquid and cissing due to air entrainment.

### DESCRIPTION OF THE PREFERRED EMBODIMENTS

Hereinafter, a coating device and a coating method according to an embodiment of the invention will be described in detail based on preferable embodiments shown in the accompanying drawings.

In the following description, the expression “to” indicating a numerical value range includes numerical values before and after “to”. For example, in a case where ε is a numerical value α to a numerical value μ, the range of ε includes the numerical value α and the numerical value β, and is represented by α≤ε≤β with mathematical symbols.

Angles such as “angles represented by concrete numerical values”, “parallel”, “perpendicular”, and “orthogonal” include error ranges which are generally accepted in the corresponding technical field, unless otherwise specified.

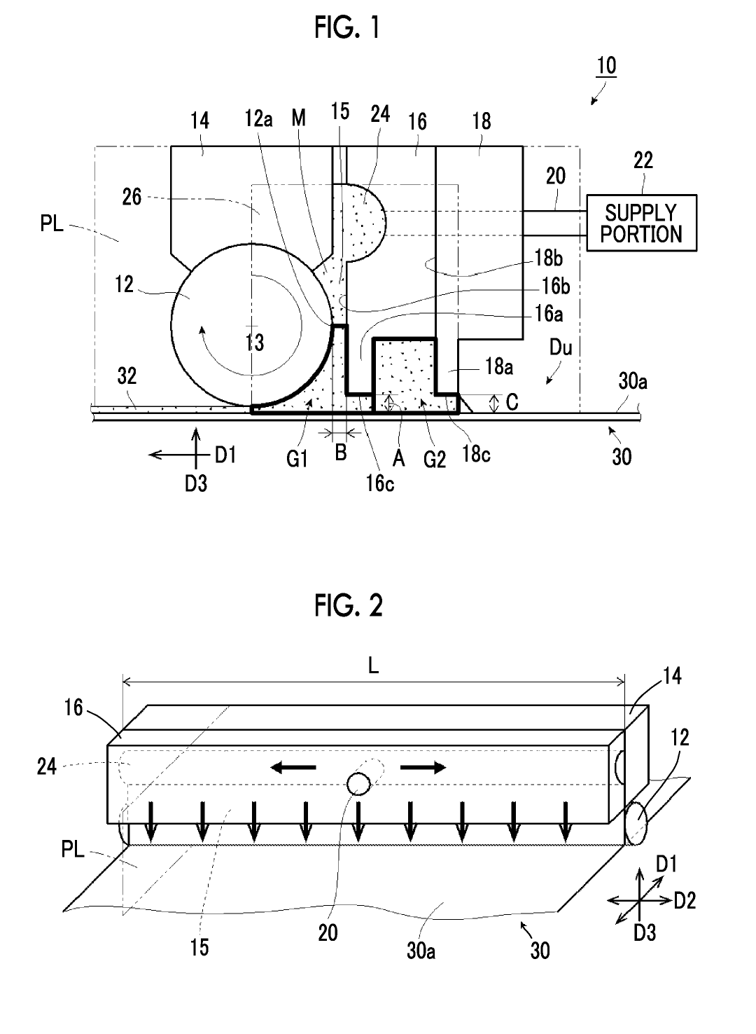

FIG. 1 is a schematic view showing a coating device according to an embodiment of the invention, and FIG. 2 is a schematic perspective view showing a main part of the coating device according to the embodiment of the invention.

A coating device 10 shown in FIG. 1 applies a coating liquid M to an upper surface 30a or a lateral surface of a long substrate 30 which continuously travels in a specific traveling direction D1. The lateral surface means that in a case where the substrate 30 which is in a state shown in FIG. 1 is rotated in a height direction D3 by 90° around the traveling direction D1, the upper surface 30a faces sideways, and the upper surface 30a at this time is called the lateral surface.

The height direction D3 is a direction perpendicular to the upper surface 30a or the lateral surface of the substrate 30. In addition, in the lateral surface, the direction of the substrate 30 is changed, and in this case, the height direction D3 of the lateral surface corresponds to a width direction D2 (see FIG. 2) in the state of the substrate 30 of FIG. 1.

The coating device 10 has a bar 12, a main body block 14, a first dam plate 16, a second dam plate 18, a supply pipe 20, a supply portion 22, and a fed-liquid storage portion 24. The coating device 10 has at least two stages of dam plates provided on the upstream side of a traveling direction D1 of a long substrate 30 with respect to the bar 12 and allowing a coating liquid M to flow to the long substrate 30 via a space between the dam plate and the bar 12. For example, the coating device has the first dam plate 16 and the second dam plate 18. The first dam plate 16 and the second dam plate 18 are arranged along the traveling direction D1.

Since at least two stages of dam plates are provided, the dam plates are not limited to the first dam plate 16 and the second dam plate 18.

The bar 12 is rotated and can be brought into contact with the upper surface 30a or the lateral surface of a long substrate 30 which continuously travels in the specific traveling direction D1 via the coating liquid M.

The bar 12 preferably has a diameter of 1 mm to 20 mm, and more preferably 6 mm to 13 mm. By setting the diameter of the bar 12 within the above range, it is possible to suppress the occurrence of vertical streaks on the surface coated with the coating liquid M.

The bar 12 is formed in a columnar shape and is rotatably supported by the main body block 14 as will be described later. The bar 12 rotates around an axis (not shown) in contact with the upper surface 30a of the traveling substrate 30 via the coating liquid M. The rotation direction of the bar 12 is not particularly limited. The rotation direction may be the same as or opposite to the traveling direction D1 of the substrate 30.

The surface of the bar 12 may be smoothly finished, but grooves may be provided at regular intervals in a circumferential direction, or a wire may be densely wound. The bar with a wire wound therearound may be a so-called wire bar. In this case, the diameter of the wire wound around the bar is preferably 0.05 to 0.5 mm, and particularly preferably 0.05 to 0.2 mm. In the bar 12 with grooves and the bar 12 with a wire wound therearound, by decreasing the depth of the groove or the thickness of the wire, the coating liquid M can be thinly applied. In addition, by increasing the depth of the groove or the thickness of the wire, the coating liquid M can be thickly applied.

The width of the bar may be the same as that of the web, but is preferably longer than the width of the web. In addition, in a case where the bar is provided with grooves or a wire, the range of the grooves or the wire provided is preferably not less than the width of the web.

The material of the bar is preferably stainless steel, and particularly preferably steel use stainless (SUS) 304 or steel use stainless (SUS) 316. A surface treatment such as hard chromium plating or diamond-like carbon (DLC) treatment may be performed on the surface of the bar.

The main body block 14 rotatably supports the bar 12, and has a structure which rotatably supports the bar 12.

For example, arc-like grooves are formed on the surface of the main body block 14 which is in contact with the bar 12. By forming the arc-like grooves in the main body block 14, it is possible to suppress bending of the bar 12 due to the tension of the substrate 30 and to form a uniform coating film 32 in the width direction D2 (see FIG. 2).

The width direction D2 (see FIG. 2) refers to a direction orthogonal to the traveling direction D1 in the upper surface 30a of the substrate 30.

In the main body block 14, it is not necessary for the materials of the side which is in contact with the bar 12 and the side which is not in contact with the bar 12 to be the same. For example, in a case where the bar 12 is made of a metal such as stainless steel, it is preferable that the side of the main body block 14 which is in contact with the bar 12 is made of a polymer resin or the like, and the side of the main body block 14 which is not in contact with the bar 12 is made of a metal such as stainless steel.

The size of the main body block 14 is appropriately determined according to the size of the bar 12. For example, it is preferable that the thickness of the main body block 14 in the traveling direction D1 is not less than the radius of the bar 12 and is twice or less the diameter of the bar 12. The height of the main body block 14 in the height direction D3 is preferably 10 to 100 mm. Furthermore, the width of the main body block 14 in the width direction D2 is preferably not less than the width of the wire or the groove provided in the bar 12.

The first dam plate 16 and the second dam plate 18 are arranged on the upper surface 30a of the substrate 30. Basically, the first dam plate 16 and the second dam plate 18 have the same configuration.

The first dam plate 16 is provided with a projecting portion 16a on the side of the upper surface 30a of the substrate 30. An end surface 16c of the projecting portion 16a opposed to the upper surface 30a is, for example, a surface parallel to the upper surface 30a of the substrate 30 in a flat state without waviness or the like.

The first dam plate 16 is provided with a slit 15 between a side surface 16b and the main body block 14 and between the side surface 16b and the bar 12. As shown in FIG. 2, the slit 15 extends in the width direction D2. The coating liquid M is fed to the slit 15.

As shown in FIG. 1, the second dam plate 18 is provided with a projecting portion 18a on the side of the upper surface 30a of the substrate 30. An end surface 18c of the projecting portion 18a opposed to the upper surface 30a is, for example, a surface parallel to the upper surface 30a of the substrate 30 in a flat state without waviness or the like.

A side surface 18b of the second dam plate 18 is in contact with the first dam plate 16. A space extending in the width direction D2 is formed by the projecting portion 16a of the first dam plate 16 and the projecting portion 18a of the second dam plate 18.

Both the end surface 16c of the first dam plate 16 and the end surface 18c of the second dam plate 18 are parallel to the upper surface 30a as described above. However, the invention is not limited thereto, and the end surfaces may be inclined.

By providing the projecting portion in the dam plate, it is possible to increase the rigidity of the whole dam plate while setting the thickness of an end portion of the dam plate to a predetermined value or less.

In addition, the fed-liquid storage portion 24 is provided at the boundary between the main body block 14 and the first dam plate 16. The fed-liquid storage portion 24 communicates with the slit 15. The fed-liquid storage portion 24 may be provided in the main body block 14 or the first dam plate 16, or may be provided across the main body block 14 and the first dam plate 16.

As shown in FIG. 2, the fed-liquid storage portion 24 is provided throughout the whole regions of the main body block 14 and the first dam plate 16 in the width direction D2. In a case where the length of the main body block 14 and the first dam plate 16 in the width direction D2 is represented by L, the fed-liquid storage portion 24 may be provided to occupy about 80% of the length L.

By providing the fed-liquid storage portion 24, the coating liquid M is allowed to uniformly flow in the width direction D2 and flow to the substrate 30, and thus the coating liquid M can be uniformly applied in the width direction D2. In a case where the fed-liquid storage portion 24 is not provided, the coating liquid M which has been fed becomes less likely to fill in the width direction D2, and the coating liquid M flows only to the portion fed with the liquid, so that an air accumulation portion 17 (see FIG. 8) in which air accumulates is formed in an end portion 25 (see FIG. 8) or the like. Bubbles introduced from the liquid feeding system or the like accumulate in the air accumulation portion 17 (see FIG. 8), and finally failure such as bubble cissing may occur.

The supply pipe 20 passes through the second dam plate 18 and the first dam plate 16, and reaches the fed-liquid storage portion 24. A supply portion 22 is connected to the supply pipe 20.

The supply portion 22 feeds the coating liquid M to the bar 12. The supply portion 22 has a tank (not shown) storing the coating liquid M, a pump (not shown) for feeding the coating liquid M, a valve (not shown) adjusting the feeding amount of the coating liquid M, and a control portion (not shown) adjusting the opening/closing amount of the valve or the like. As the supply portion 22, a known liquid supply device capable of supplying a predetermined amount of liquid can be appropriately used.

The total thickness of the first dam plate 16 and the second dam plate 18, excluding the projecting portions thereof, is preferably within a range of 5 to 50 mm. The total thickness is the length in the traveling direction D1.

The lengths of the first dam plate 16 and the second dam plate 18 in the height direction D3 are preferably 10 to 100 mm, and the widths of the first dam plate 16 and the second dam plate 18 are, for example, the same as that of the main body block 14.

The material of the first dam plate 16 and the second dam plate 18 is not particularly limited, and for example, a metal or a resin. Examples of the metal include stainless steel, and particularly, steel use stainless (SUS) 304 or steel use stainless (SUS) 316 is preferably used.

In addition to this, a metal subjected to hard chromium plating or a diamond-like carbon treatment may be used as a dam plate.

Among the first dam plate 16 and the second dam plate 18 provided on an upstream side Du of the bar 12, the first dam plate 16 which is the closest to the bar 12 can increase the internal pressure of the coating liquid M. For this reason, cissing occurring by air entrainment can be suppressed. The cissing occurring by air entrainment will be described in detail later. The cissing occurring by air entrainment is also simply referred to as air entrainment cissing.

The second dam plate 18 on the upstream side Du of the first dam plate 16 can make the distribution of the coating liquid M in the width direction D2 uniform by forcibly forming a liquid pool with the first dam plate 16. By making the distribution of the coating liquid M in the width direction D2 uniform, air entrainment cissing and exhaustion of the coating liquid can be suppressed over the whole width in the width direction D2.

In the coating device 10, a cross-sectional area of a first portion G1 surrounded by the bar 12, the first dam plate 16 closest to the bar 12, and a long substrate 30 in a plane PL formed by the traveling direction D1 and the height direction D3 is defined as a first bead cross-sectional area S1.

A cross-sectional area of a second portion G2 surrounded by the first dam plate 16, the second dam plate 18 on the most upstream side in the traveling direction D1, and a long substrate 30 in the plane PL formed by the traveling direction D1 and the height direction D3 is defined as a second bead cross-sectional area S2. In this case, the sum of the first bead cross-sectional area S1 and the second bead cross-sectional area S2 is preferably 20 mm² or greater, and a distance C between the second dam plate 18 and the long substrate 30 is preferably 0 mm to 5 mm.

By setting the sum of the first bead cross-sectional area S1 and the second bead cross-sectional area S2 to 20 mm² or greater, the liquid pool becomes large, and thus even in a case where a substrate 30 with poor smoothness is fed, liquid exhaustion does not occur since a surplus coating liquid M accumulates in the liquid pool portion. The upper limit value of the sum of the first bead cross-sectional area S1 and the second bead cross-sectional area S2 is 1000 mm² or less.

In a case where the sum of the first bead cross-sectional area S1 and the second bead cross-sectional area S2 is reduced, the liquid pool portion becomes small. Accordingly, in a case where a substrate 30 with poor smoothness is transported, the distribution of the coating liquid M in the width direction D2 deteriorates, and thus liquid exhaustion easily occurs.

In a case where the distance C between the second dam plate 18 and the long substrate 30 is greater than 5 mm, the coating liquid M flows out to the upstream side Du in the traveling direction D1, and thus the coating liquid M cannot be accumulated, and the distribution of the coating liquid M in the width direction D2 becomes nonuniform.

The fact that the distance C between the second dam plate 18 and the long substrate 30 is 0 mm means that the second dam plate 18 is brought into contact with the substrate 30. For example, the end surface 18c is brought into contact with the substrate 30.

The distance C between the second dam plate 18 and the long substrate 30 refers to the length between the lowermost portion of the second dam plate 18 and the uppermost portion of the substrate 30, and the shortest distance between the second dam plate 18 and the substrate 30. In the configuration of FIG. 1, the distance C is the shortest distance between the end surface 18c of the second dam plate 18 and the upper surface 30a of the substrate 30.

The first bead cross-sectional area S1 is preferably 20 mm² or less. In addition, a distance B, which is the shortest distance between an end surface 12a of the bar 12 on the upstream side Du in the traveling direction D1 and the first dam plate 16 is preferably 0.05 mm to 2 mm, and a distance A between the first dam plate 16 and the long substrate 30 is preferably 0.2 mm to 2 mm.

By setting the first bead cross-sectional area S1 to 20 mm² or less, the internal pressure of the coating liquid M can be increased, and thus the occurrence of air entrainment cissing can be suppressed. In a case where the first bead cross-sectional area S1 is greater than 20 mm², it becomes difficult to increase the internal pressure of the coating liquid M, and thus air entrainment cissing easily occurs.

In a case where the distance B between the end surface 12a of the bar 12 on the upstream side Du in the traveling direction D1 and the first dam plate 16 is less than 0.05 mm, the coating liquid M is not uniformly supplied in the width direction D2 from the slit 15 between the bar 12 and the first dam plate 16.

On the other hand, in a case where the distance B to the first dam plate 16 is greater than 2 mm, it becomes difficult to increase the internal pressure of the coating liquid M, and thus air entrainment cissing easily occurs. More preferably, the distance B between the end surface 12a of the bar 12 on the upstream side Du in the traveling direction D1 and the first dam plate 16 is 0.1 mm to 1 mm.

In a case where the distance A between the first dam plate 16 and the long substrate 30 is less than 0.2 mm, the coating liquid M flowing to the upstream side Du in the traveling direction D1 disappears, and thus extrusion of the coating liquid M easily occurs.

On the other hand, in a case where the distance A between the first dam plate 16 and the long substrate 30 is greater than 2 mm, it becomes difficult to increase the internal pressure of the coating liquid M, and thus air entrainment cissing easily occurs. More preferably, the distance A between the first dam plate 16 and the long substrate 30 is 0.4 mm to 1 mm.

The distance A between the first dam plate 16 and the long substrate 30 refers to the length between the lowermost portion of the first dam plate 16 and the uppermost portion of the substrate 30, and the shortest distance between the first dam plate 16 and the substrate 30. In the configuration of FIG. 1, the distance A is the shortest distance between the end surface 16c of the first dam plate 16 and the upper surface 30a of the substrate 30.

Next, a coating method of the coating device 10 will be described.

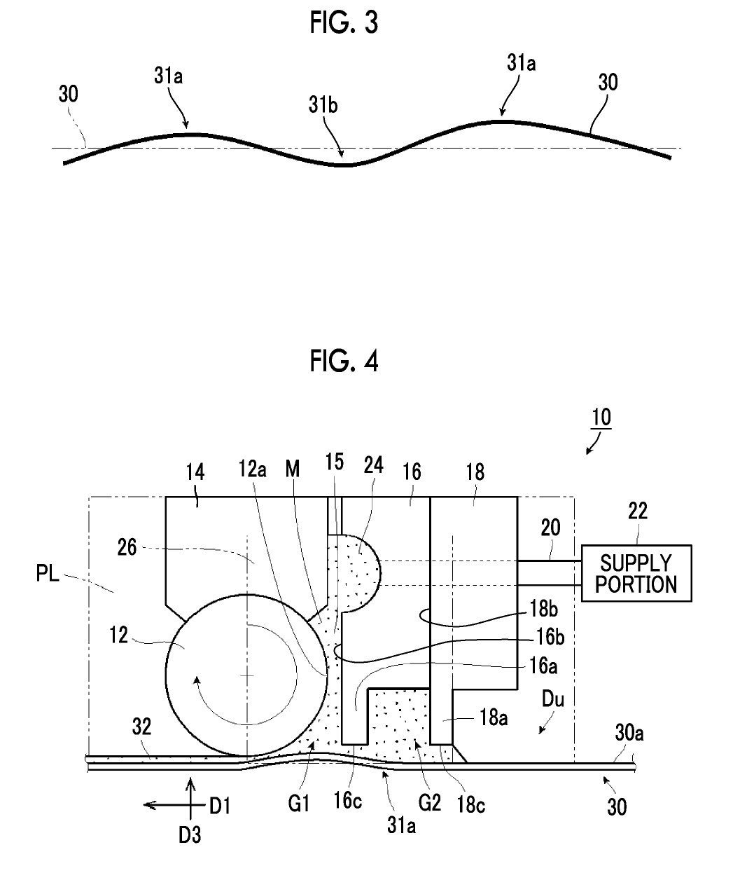

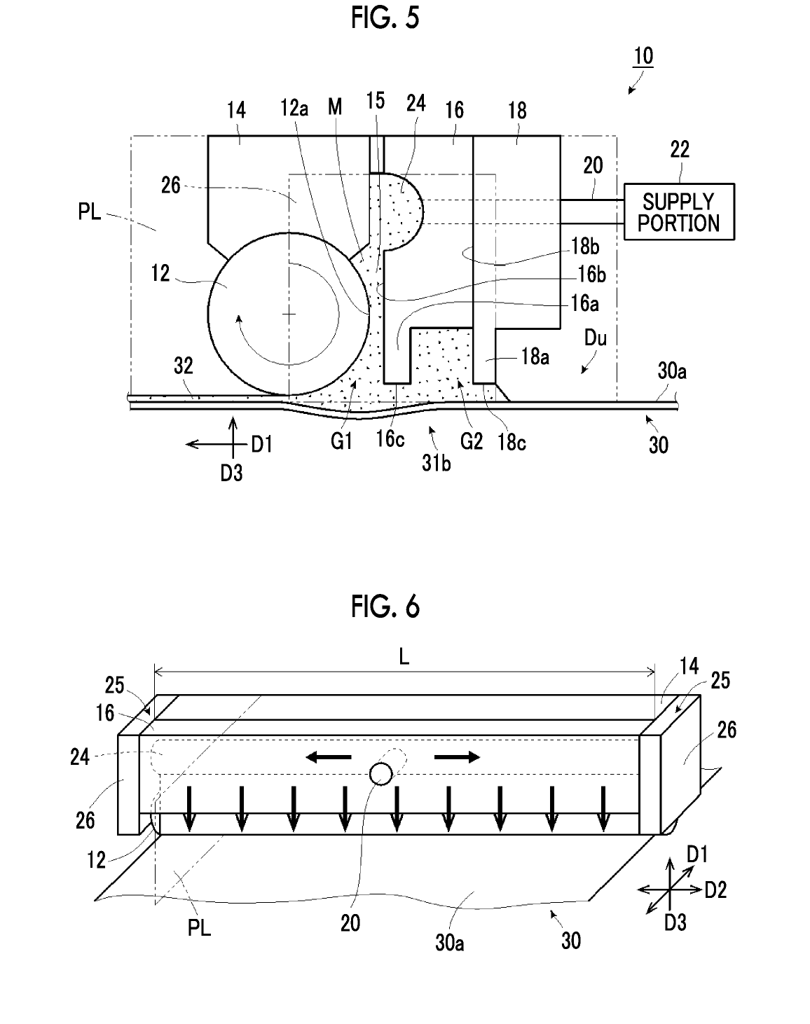

FIG. 3 is a schematic view showing a traveling state of a long substrate. FIG. 4 is a schematic view for illustrating an operation of the coating device according to the embodiment of the invention. FIG. 5 is a schematic view for illustrating an operation of the coating device according to the embodiment of the invention.

The coating liquid M is supplied from the supply portion 22 via the supply pipe 20, and fills the slit 15 through the fed-liquid storage portion 24. In addition, the bar 12 is rotated. A substrate 30 is continuously traveled in the traveling direction D1 at a specific traveling speed to bring the bar 12 into contact with an upper surface 30a of the substrate 30 which continuously travels via the coating liquid M. Thus, the coating liquid M can be applied to the upper surface 30a of the substrate 30, and a coating film 32 can be continuously formed.

In the coating device 10, it is possible to improve the uniformity of coating of the coating liquid M on the upper surface 30a of the substrate 30 by providing two stages of dam plates. Even in a case where the traveling speed of the substrate 30 is high, the coating film 32 can be formed without the occurrence of liquid exhaustion.

In the long substrate 30, a region with poor smoothness may be generated. For example, as shown in FIG. 3, a convex portion 31a or a concave portion 31b is generated in a case where the long substrate 30 has waviness. In a case where the coating liquid M is applied to the upper surface 30a of the substrate 30 in the coating device 10, the coating liquid M can be moved and applied to the second portion G2 even in a state in which the convex portion 31a of the substrate 30 is transported to the first portion G1 and the upper surface 30a of the substrate 30 rises to the first portion G1 as shown in FIG. 4, and thus the coating film 32 can be continuously formed.

In addition, even in a state in which the concave portion 31b of the substrate 30 is transported to the first portion G1 and the upper surface 30a of the substrate 30 is lowered as shown in FIG. 5, coating can be performed without the occurrence of liquid exhaustion since a surplus coating liquid M accumulates in the first portion G1, and the coating film 32 can be continuously formed.

In this manner, in the coating device 10, the coating film 32 can be continuously formed without liquid exhaustion regardless of the state of the substrate 30. Moreover, since two stages of dam plates, that is, the first dam plate 16 and the second dam plate 18 are provided, and the first dam plate 16 increases the internal pressure of the coating liquid M, air entry from the upstream side Du is suppressed, and air entrainment cissing is suppressed.

In addition, the fed-liquid storage portion 24 is provided, the occurrence of bubble cissing is suppressed, and the coating liquid M can be uniformly applied in the width direction D2 of the substrate 30.

Although the coating method of the coating device 10 has been described as being performed on the upper surface 30a of the substrate 30, the coating can also be performed on the lateral surface of the substrate 30.

FIG. 6 is a schematic perspective view showing a side plate of the coating device according to the embodiment of the invention.

As shown in FIG. 6, the coating device 10 may be configured to include a side plate 26 provided at the end portion 25. The use efficiency of the coating liquid M can be increased by providing the side plate 26. In a case where the side plate 26 is not provided, the coating liquid M may flow out from the end portion 25, and the amount of the coating liquid M necessary for coating increases.

The material of the side plate 26 is not particularly limited, and for example, the side plate is made of a metal such as steel use stainless (SUS) or a resin.

Next, another example of the coating device will be described.

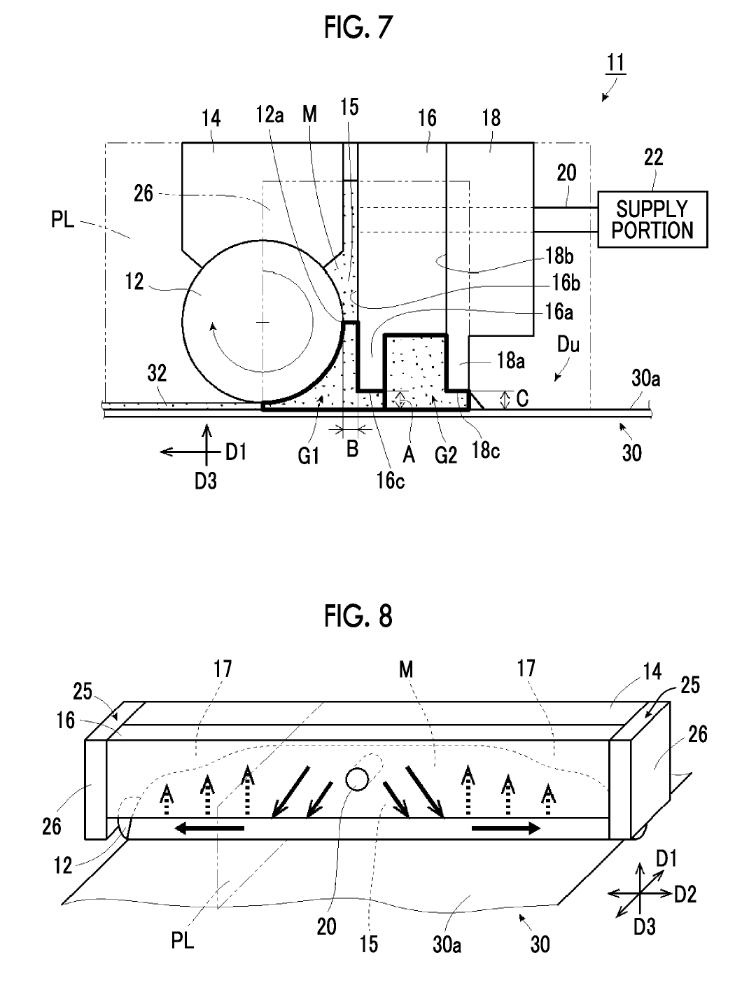

FIG. 7 is a schematic view showing another example of the coating device according to the embodiment of the invention. FIG. 8 is a schematic perspective view showing a side plate of another example of the coating device according to the embodiment of the invention.

In a coating device 11 shown in FIGS. 7 and 8, the same components as those of the coating device 10 shown in FIGS. 1 and 2 will be denoted by the same references, and detailed description thereof will be omitted.

The coating device 11 shown in FIG. 7 differs from the coating device 10 shown in FIG. 1 in that the fed-liquid storage portion 24 is not provided, and other configurations are the same as in the coating device 10 shown in FIG. 1. Therefore, detailed description thereof will be omitted.

The coating device 11 can obtain the same effect as that of the above-described coating device 10 with respect to the exhaustion of a coating liquid M. Since the fed-liquid storage portion 24 is not provided, an air accumulation portion 17 (see FIG. 8) in which air accumulates is formed in an end portion 25 (see FIG. 8) or the like. Since bubbles introduced from the liquid feeding system or the like accumulate in the air accumulation portion 17 (see FIG. 8), the bubble cissing suppression effect is reduced.

The coating device 11 may be configured to include a side plate 26 provided at the end portion 25 as shown in FIG. 8. The use efficiency of the coating liquid M can be increased by providing the side plate 26.

Next, the substrate 30 and the coating liquid M which are used in the above-described coating devices 10 and 11 will be described.

(Substrate)

Examples of the substrate include a glass material, a metal material, an alloy material, paper, a plastic film, resin-coated paper, synthetic paper, and cloth. Examples of the material of the plastic film include polyolefins such as polyethylene and polypropylene, vinyl polymers such as polyvinyl acetate, polyvinyl chloride, and polystyrene, polyamides such as 6,6-nylon and 6-nylon, polyesters such as polyethylene terephthalate and polyethylene-2,6-naphthalate, and cellulose acetates such as polycarbonate, cellulose triacetate, and cellulose diacetate. Representative examples of the resin which is used for resin-coated paper include polyolefin such as polyethylene.

The thickness of the substrate is not particularly limited, and those having a thickness of 0.01 to 1.5 mm are preferably used from the viewpoint of handleability and versatility.

The substrate is brought into contact with the bar via the coating liquid in a state in which a tension is applied. The angle which is formed between the substrate and the horizontal plane is preferably 0° to 10°, and more preferably 0° to 5° on both the upstream side and the downstream side of the bar. By setting the angle of the substrate within the above range, the coated surface can be made uniform, and wear of the bar and the like can be suppressed.

The form of the substrate is not particularly limited, and examples thereof include a sheet form and a continuous strip form. A continuous strip-like substrate, that is, a long substrate is referred to as a web.

(Coating Liquid)

The coating liquid includes various liquid substances.

Examples of the solvent in the coating liquid include water and an organic solvent. Examples of the organic solvent include methyl ethyl ketone (MEK), methyl propylene glycol (MFG), and methanol.

The binder includes monomers or polymers, such as polyurethane, polyester, polyolefin, acryl, and polyvinyl alcohol (PVA). In addition, the coating liquid may contain, for example, silicon oxide particles and titanium oxide particles as a solid content.

Regarding the coating liquid, a viscosity of 7×10⁻⁴ to 0.4 Pa·s (0.7 to 400 centipoise (cP)), a coating amount of 0.1 to 200 milliliters (ml)/m² (1 to 200 cc/m²), and a coating speed of 1 to 400 m/min can be applied.

Preferably, the viscosity is 1×10⁻³ to 0.1 Pa·s (1 to 100 cP), the coating amount is 1 to 100 ml/m² (1 to 100 cc/m²), and the coating speed is 1 to 200 m/min.

Examples of the coating liquid include, in addition to the above-described substances, a solution which is applied to a substrate and dried to form a film. Specific examples thereof include, in addition to a photosensitive layer forming liquid and a heat-sensitive layer forming liquid, an intermediate layer forming liquid which is used to form an intermediate layer on a surface of the substrate to improve adhesion of the plate-making layer, a polyvinyl alcohol aqueous solution which is used to protect a plate-making surface of the planographic printing plate precursor from oxidation, a photosensitive agent colloidal liquid for a photographic film which is used to form a photosensitive layer in the photographic film, a photosensitive agent colloidal liquid for photographic paper which is used to form a photosensitive layer of the photographic paper, a magnetic layer forming liquid which is used to form a magnetic layer of a recording tape, a video tape, or a floppy disk, and various paints which are used for metal coating.

(Applications)

The coating device and the coating method can be applied to all fields in which products are manufactured by applying a liquid film on a metal, paper, cloth, a film, or the like using a bar, and applications thereof are not particularly limited.

Regarding applications of the coating device and the coating method, the coating device and the coating method can be used in, for example, coating using a bar, such as the manufacturing of a photosensitive material such as a photographic film, the manufacturing of a magnetic recording material such as a recording tape, and the manufacturing of a coated sheet metal such as a color iron plate. Accordingly, examples of the substrate include, in addition to the support substrate described in the related art, a continuous strip-like base material made of a metal, plastic, or paper and having flexibility, such as a planographic printing plate precursor having a photosensitive or heat-sensitive plate-making surface formed on a surface of the support substrate on the ground side, a base material for a photographic film, baryta paper for photographic paper, a base material for a recording tape, a base material for a video tape, and a base material for a floppy (registered trademark) disk.

In addition, examples of the coating liquid include, in addition to the above-described substances, a solution which is applied to a substrate and dried to form a film, and specific examples thereof include, in addition to a photosensitive layer forming liquid and a heat-sensitive layer forming liquid, an intermediate layer forming liquid which is used to form an intermediate layer on a surface of the substrate to improve adhesion of the plate-making layer, a polyvinyl alcohol aqueous solution which is used to protect a plate-making surface of the planographic printing plate precursor from oxidation, a photosensitive agent colloidal liquid for a photographic film which is used to form a photosensitive layer in the photographic film, a photosensitive agent colloidal liquid for photographic paper which is used to form a photosensitive layer of the photographic paper, a magnetic layer forming liquid which is used to form a magnetic layer of a recording tape, a video tape, or a floppy disk, and various paints which are used for metal coating.

In addition, by using the coating device and the coating method, it is possible to efficiently form a coated surface on both surfaces of the substrate. In the past, a lower surface coating device has been used in many cases in forming a uniform coating film, and in this case, it has been necessary to change the transport direction by a substrate transport roll after providing a first lower surface coating step, and to provide a second lower surface coating step again. Accordingly, the transport distance until the formation of the coated surface on both surfaces has been increased, and it has been necessary to widen a coating space of the coating liquid.

However, by using the coating device and the coating method, a uniform coating film can be formed even in the upper surface coating. Therefore, in a case where a coated surface is formed on both surfaces of the substrate, it is possible to simultaneously perform the conventional lower surface coating and the upper surface coating using the above-described coating device, thereby saving the coating space. As a result, the film forming steps can be simplified, and the manufacturing cost can also be reduced.

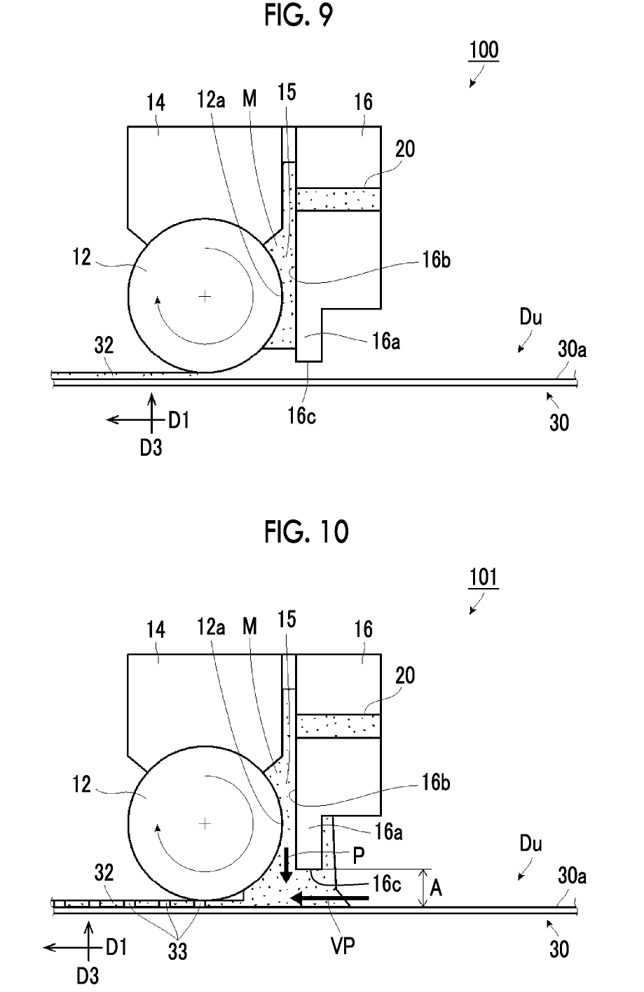

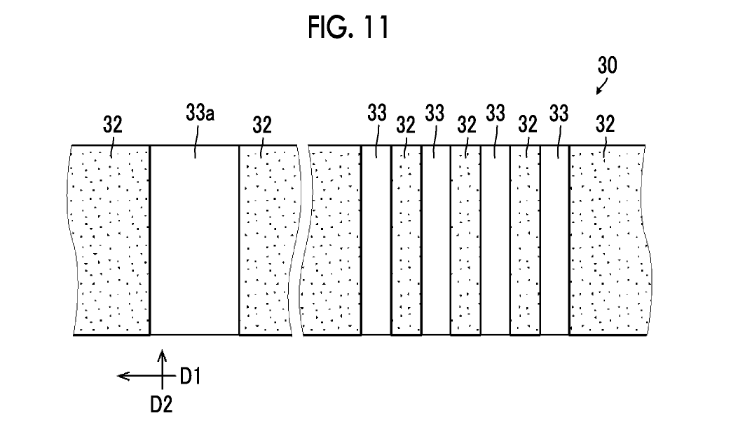

Here, FIG. 9 is a schematic view for illustrating exhaustion of a coating liquid. FIG. 10 is a schematic view for illustrating cissing due to air entrainment. FIG. 11 is a schematic plan view showing a result of coating including exhaustion of a coating liquid and cissing due to air entrainment.

In a coating device 100 shown in FIG. 9 and a coating device 101 shown in FIG. 10, the same components as those of the coating device 11 shown in FIG. 7 will be denoted by the same references, and detailed description thereof will be omitted.

The coating device 100 shown in FIG. 9 differs from the coating device 11 shown in FIG. 7 in that only the first dam plate 16 is provided, and the dam plate has a single-stage configuration, and other configurations are the same as in the coating device 11 shown in FIG. 7. Therefore, detailed description thereof will be omitted.

In the coating device 100, in a case where a substrate 30 with poor smoothness is transported, a coating liquid M overflows at a place where the clearance between the substrate and the end surface 16c of the first dam plate 16 is wide, and thus the coating liquid M is not supplied to the upper surface 30a of the substrate 30 and liquid exhaustion occurs. As a result, as shown in FIG. 11, a region 33a having no film is formed in a coating film 32.

The coating device 101 shown in FIG. 10 differs from the coating device 11 shown in FIG. 7 in that only the first dam plate 16 is provided, the dam plate has a single-stage configuration, and the distance A is long, and other configurations are the same as in the coating device 11 shown in FIG. 7. Therefore, detailed description thereof will be omitted.

In a case where the distance A is increased to prevent the exhaustion of a coating liquid M as in the coating device 101, air enters between the end surface 16c of the first dam plate 16 and the upper surface 30a of the substrate 30. In a case where a pressure VP of the air is equal to or higher than a pressure P of the coating liquid M against the upper surface 30a of the substrate 30, air from outside passes between the end surface 16c of the first dam plate 16 and the upper surface 30a of the substrate 30, and enters the coating liquid M, and cissing occurs due to air entrainment. As a result, as shown in FIG. 11, a coating film 32 is not continuously formed, and a region 33 having no film is intermittently formed along the traveling direction D1. Cissing due to air entrainment includes not only the region where no film is formed but also a partial reduction in film thickness of the coating film 32. The above-described air pressure VP is also referred to as an entrained air pressure.

Basically, the invention is configured as described above. Although the coating device and the coating method according to the embodiment of the invention have been described in detail, the invention is not limited to the above-described embodiments, and various improvements or modifications may be made without departing from the gist of the invention.

### EXAMPLES

Hereinafter, characteristics of the invention will be more specifically described with examples. Materials, reagents, used amounts, substance amounts, ratios, treatment contents, treatment procedures, and the like shown in the following examples are able to be properly changed without departing from the intent of the invention. Therefore, the scope of the invention will not be restrictively interpreted by the following specific examples.

In the examples, a coating liquid was applied to a substrate using coating devices of Examples 1 to 7 and Comparative Example 1, and coating therewith was evaluated.

In the coating device, the bar diameter was set to 10 mm, and the width was set to 800 mm. In addition, the bar rotation speed was 1,500 rotations/min (rpm). Coating was performed with a primary side substrate entry angle of 5° such that a stationary portion had a film thickness of 5 μm. The primary side substrate entry angle refers to an angle at which the substrate enters from the upstream side of the bar.

As the substrate, a polyethylene terephthalate (PET) film having a width of 700 mm was used.

As the coating liquid, a solution prepared by dissolving a polyester resin, a crosslinking agent, and a surfactant in water was used. The coating liquid was prepared so as to have a viscosity of 2 mPa·s by adjusting the amount of the composition. The surface tension of the coating liquid was 40 mN/m.

In the evaluation of coating, liquid exhaustion, air entrainment cissing, and bubble cissing were evaluated.

Regarding liquid exhaustion, the traveling speed of the substrate was changed between 40 m/min and 100 m/min, and the limit speed of the liquid exhaustion was checked. That is, a traveling speed at which liquid exhaustion occurred was checked. A coating film after coating was visually observed for 1 minute to evaluate the liquid exhaustion based on the following criteria for liquid exhaustion evaluation.

Criteria for Liquid Exhaustion Evaluation

A: Liquid exhaustion occurred at a traveling speed of more than 60 m/min and 100 m/min or less.

B: Liquid exhaustion occurred at a traveling speed of more than 40 m/min and 60 m/min or less.

C: Liquid exhaustion occurred at a traveling speed of 40 m/min or less.

Regarding air entrainment cissing, coating was performed at a traveling speed of 100 m/min, and a coating film after coating was visually observed for 1 minute to check the presence or absence of cissing in the coating film. A case where cissing was observed during 1-minute observation was evaluated as “presence”, and a case where no cissing was observed during 1-minute observation was evaluated as “absence”.

Regarding bubble cissing, coating was performed at a traveling speed of 100 m/min, and a coating film after coating was visually observed for 1 minute to check the presence or absence of cissing in the coating film. A case where cissing was observed during 1-minute observation was evaluated as “presence”, and a case where no cissing was observed during 1-minute observation was evaluated as “absence”.

The coating device of Example 1 was configured as shown in FIG. 7, and the coating devices of Examples 2 to 7 were configured as shown in FIG. 1. The coating device of Comparative Example 1 was configured as shown in FIG. 9.

Hereinafter, Examples 1 to 7 and Comparative Example 1 will be described.

### Example 1

In Example 1, the distance A between the first dam plate 16 and the substrate 30 was 0.5 mm, the distance B as the shortest distance between the end surface 12a on the upstream side in the traveling direction D1 and the first dam plate 16 was 0.2 mm, and the distance C between the second dam plate 18 and the substrate 30 was 0.5 mm.

The first bead cross-sectional area S1 was 13 mm², the second bead cross-sectional area S2 was 10 mm², and the total bead cross-sectional area of the first bead cross-sectional area S1 and the second bead cross-sectional area S2 was 23 mm². In addition, a minimum liquid feed rate at which coating was possible was checked, and it was 500 ml/min.

The minimum liquid feed rate at which coating is possible (hereinafter, referred to as a minimum liquid feed rate for coating) represents a minimum liquid feed rate at which an end portion in the width direction of the coating device can be coated at a traveling speed of 100 m/min.

### Example 2

Example 2 was the same as Example 1, except that a fed-liquid storage portion was provided.

### Example 3

Example 3 was the same as Example 2, except that the distance A was 2.5 mm, the first bead cross-sectional area S1 was 24 mm², and the total bead cross-sectional area was 34 mm².

### Example 4

Example 4 was the same as Example 2, except that the distance B was 2.5 mm, the first bead cross-sectional area S1 was 23 mm², and the total bead cross-sectional area was 33 mm².

### Example 5

Example 5 was the same as Example 2, except that the second bead cross-sectional area S2 was 5 mm², and the total bead cross-sectional area was 18 mm².

### Example 6

Example 6 was the same as Example 2, except that the distance C was 5.5 mm, the second bead cross-sectional area S2 was 13 mm², and the total bead cross-sectional area was 26 mm².

### Example 7

Example 7 was the same as Example 2, except that a side plate was provided, and the minimum liquid feed rate for coating was 400 ml/min.

### Comparative Example 1

Comparative Example 1 was the same as Example 1, except that the second dam plate 18 was not provided, and the first bead cross-sectional area S1 was 13 mm². In Comparative Example 1, the dam plate has a single-stage configuration, and the second bead cross-sectional area S2 is not present.

TABLE 1

| | Coating Conditions | | | | | | | | | | | | |
|---|---|---|---|---|---|---|---|---|---|---|---|---|---|
| | | | | | | | Total | Presence | | | | | |
| | | | | | First | Second | Bead | or | | Minimum | | | |
| | | | | | Bead | Bead | Cross- | Absence | Presence | Liquid | Evaluation Results | | |
| | | Dis- | Dis- | Dis- | Cross- | Cross- | Sectional | of Fed- | or | Feed | | Air | |
| | Number | tance | tance | tance | Sectional | Sectional | Area | Liquid | Absence | Rate for | Liquid | Entrain- | |
| | of | A | B | C | Area S1 | Area S2 | S1 + | Storage | of Side | Coating | Exhaus- | ment | Bubble |
| | Stages | (mm) | (mm) | (mm) | (mm²) | (mm²) | S2 (mm²) | Portion | Plate | (ml/min) | tion | Cissing | Cissing |
| Comparative | 1 | 0.5 | 0.2 | — | 13 | — | 13 | Absence | Absence | 500 | C | Absence | Presence |
| Example 1 | | | | | | | | | | | | | |
| Example 1 | 2 | 0.5 | 0.2 | 0.5 | 13 | 10 | 23 | Absence | Absence | 500 | A | Absence | Presence |
| Example 2 | 2 | 0.5 | 0.2 | 0.5 | 13 | 10 | 23 | Presence | Absence | 500 | A | Absence | Absence |
| Example 3 | 2 | 2.5 | 0.2 | 0.5 | 24 | 10 | 34 | Presence | Absence | 500 | A | Presence | Absence |
| Example 4 | 2 | 0.5 | 2.5 | 0.5 | 23 | 10 | 33 | Presence | Absence | 500 | A | Presence | Absence |
| Example 5 | 2 | 0.5 | 0.2 | 0.5 | 13 | 5 | 18 | Presence | Absence | 500 | B | Absence | Absence |
| Example 6 | 2 | 0.5 | 0.2 | 5.5 | 13 | 13 | 26 | Presence | Absence | 500 | B | Absence | Absence |
| Example 7 | 2 | 0.5 | 0.2 | 0.5 | 13 | 10 | 23 | Presence | Presence | 400 | A | Absence | Absence |

As shown in Table 1, in Examples 1 to 7, a good result was obtained with regard to liquid exhaustion. In Examples 2 to 7 having a side plate, a good result was obtained with regard to bubble cissing.

In Example 3, the distance A was large, and in Example 4, the distance B was large. Accordingly, a poor result was obtained in the evaluation of air entrainment cissing.

In Example 5, the total bead cross-sectional area was small, and in Example 6, the distance C was large. Accordingly, a slightly poor result was obtained in the evaluation of liquid exhaustion.

In Example 7, a good result was obtained with regard to liquid exhaustion, air entrainment cissing, and bubble cissing even with a low minimum liquid feed rate for coating.

In Comparative Example 1, the dam plate had a single-stage configuration, and a poor result was obtained in the evaluation of liquid exhaustion. A poor result was also obtained in the evaluation of bubble cissing since no side plate was provided.

### EXPLANATION OF REFERENCES

10, 11, 100, 101: coating device
12: bar
12a: end surface
14: main body block
15: slit
16: first dam plate
16a, 18a: projecting portion
16b, 18b: side surface
16c, 18c: end surface
17: air accumulation portion
18: second dam plate
20: supply pipe
22: supply portion
24: fed-liquid storage portion
25: end portion
26: side plate
30: substrate
30a: upper surface
31a: convex portion
31 b: concave portion
32: coating film
33, 33a: region
A: distance
B: distance
C: distance
D1: traveling direction
D2: width direction
D3: height direction
Du: upstream side
G1: first portion
G2: second portion
M: coating liquid
P: pressure
PL: plane
VP: air pressure

What is claimed is:

1. A coating device which applies a coating liquid to an upper surface or a lateral surface of a long substrate continuously traveling in a specific traveling direction, the device comprising:
a bar which is capable of being brought into contact with the upper surface or the lateral surface of the long substrate continuously traveling in the traveling direction via the coating liquid, and is rotated; and
at least two stages of dam plates which are provided on the upstream side in the traveling direction of the long substrate with respect to the bar, and allow the coating liquid to flow to the long substrate via a space between the dam plate and the bar,
wherein the at least two stages of dam plates are arranged along the traveling direction.

2. The coating device according to claim 1,
wherein in a case where a cross-sectional area of a first portion surrounded by the bar, a dam plate closest to the bar among the dam plates, and the long substrate in a plane formed by the traveling direction and a height direction is defined as a first bead cross-sectional area, and a cross-sectional area of a second portion surrounded by the dam plate closest to the bar, a dam plate on the most upstream side in the traveling direction among the dam plates, and the long substrate in the plane formed by the traveling direction and the height direction is defined as a second bead cross-sectional area, a sum of the first bead cross-sectional area and the second bead cross-sectional area is 20 mm² or greater,
a distance between the dam plate on the most upstream side and the long substrate is 0 mm to 5 mm, and
the height direction is a direction perpendicular to the upper surface or the lateral surface of the substrate.

3. The coating device according to claim 1,
wherein in a case where a cross-sectional area of a first portion surrounded by the bar, a dam plate closest to the bar among the dam plates, and the long substrate in a plane formed by the traveling direction and a height direction is defined as a first bead cross-sectional area, the first bead cross-sectional area is 20 mm² or less,
the shortest distance between an end surface of the bar on the upstream side in the traveling direction and the dam plate closest to the bar is 0.05 mm to 2 mm,
a distance between the dam plate closest to the bar and the long substrate is 0.2 mm to 2 mm, and
the height direction is a direction perpendicular to the upper surface or the lateral surface of the substrate.

4. The coating device according to claim 2,
wherein in a case where a cross-sectional area of a first portion surrounded by the bar, a dam plate closest to the bar among the dam plates, and the long substrate in a plane formed by the traveling direction and a height direction is defined as a first bead cross-sectional area, the first bead cross-sectional area is 20 mm² or less,
the shortest distance between an end surface of the bar on the upstream side in the traveling direction and the dam plate closest to the bar is 0.05 mm to 2 mm,
a distance between the dam plate closest to the bar and the long substrate is 0.2 mm to 2 mm, and
the height direction is a direction perpendicular to the upper surface or the lateral surface of the substrate.

5. The coating device according to claim 1, further comprising:
a main body block which rotatably supports the bar; and
a fed-liquid storage portion which is provided in the main body block or the dam plate to store the coating liquid.

6. The coating device according to claim 2, further comprising:
a main body block which rotatably supports the bar; and
a fed-liquid storage portion which is provided in the main body block or the dam plate to store the coating liquid.

7. The coating device according to claim 3, further comprising:
a main body block which rotatably supports the bar; and
a fed-liquid storage portion which is provided in the main body block or the dam plate to store the coating liquid.

8. The coating device according to claim 4, further comprising:
a main body block which rotatably supports the bar; and
a fed-liquid storage portion which is provided in the main body block or the dam plate to store the coating liquid.

9. The coating device according to claim 1, further comprising:
a side plate which is provided at ends of the bar and the at least two stages of dam plates in a width direction orthogonal to the traveling direction in the upper surface or the lateral surface of the substrate.

10. The coating device according to claim 2, further comprising:
a side plate which is provided at ends of the bar and the at least two stages of dam plates in a width direction orthogonal to the traveling direction in the upper surface or the lateral surface of the substrate.

11. The coating device according to claim 3, further comprising:
a side plate which is provided at ends of the bar and the at least two stages of dam plates in a width direction orthogonal to the traveling direction in the upper surface or the lateral surface of the substrate.

12. The coating device according to claim 4, further comprising:
a side plate which is provided at ends of the bar and the at least two stages of dam plates in a width direction orthogonal to the traveling direction in the upper surface or the lateral surface of the substrate.

13. The coating device according to claim 5, further comprising:
a side plate which is provided at ends of the bar and the at least two stages of dam plates in a width direction orthogonal to the traveling direction in the upper surface or the lateral surface of the substrate.

14. The coating device according to claim 6, further comprising:
a side plate which is provided at ends of the bar and the at least two stages of dam plates in a width direction orthogonal to the traveling direction in the upper surface or the lateral surface of the substrate.

15. The coating device according to claim 7, further comprising:
a side plate which is provided at ends of the bar and the at least two stages of dam plates in a width direction orthogonal to the traveling direction in the upper surface or the lateral surface of the substrate.

16. The coating device according to claim 8, further comprising:
a side plate which is provided at ends of the bar and the at least two stages of dam plates in a width direction orthogonal to the traveling direction in the upper surface or the lateral surface of the substrate.

17. A coating method comprising:
applying a coating liquid to an upper surface or a lateral surface of a long substrate continuously traveling by using the coating device according to claim 1.

18. A coating method comprising:
applying a coating liquid to an upper surface or a lateral surface of a long substrate continuously traveling by using the coating device according to claim 2.
